(19) United States
(12) Patent Application Publication
(10) Pub. No.: US 2007/0288645 A1
(43) Pub. Date: Dec. 13, 2007

(54) Method and System for Persistent and Reliable Data Transmission

(75) Inventor: Eric Kass, Mannheim (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/757,632

(22) Filed: Jun. 4, 2007

(30) Foreign Application Priority Data
Jun. 8, 2006 (DE) 06115138.7

(51) Int. Cl. G06F 15/16

(52) U.S. Cl. 709/230; 709/227

(57) ABSTRACT

A method of transmitting data over a network, comprising: at a first proxy computer system, receiving data from a first data channel, encapsulating the data in packets, and sending the encapsulated data packets over a second data channel comprising a firewall, and at a second proxy computer system, receiving the data packets from the second data channel, extracting the data from the data packets, and sending the data on a third data channel, wherein said data channels are connection-oriented sequential data-stream channels, and an established connection on the first data channel is maintained if an interruption of an established connection on the second data channel between the first and the second proxy computer system is detected, and a network device, data processing program, computer program product, computer data signal and network data structure therefor.

### FIELD OF THE INVENTION

The invention relates to a method of transmitting data over a network, and a network device and computer program product therefor.

### BACKGROUND OF THE INVENTION

For establishing reliable data communications on networks, connection-oriented sequential data stream protocols are known, such as the Transmission Control Protocol (TCP). The use of such protocols is intended to establish a point-to-point data channel on which communication is reliably transmitted. In particular, an established point-to-point connection is to be maintained over long distances and across unreliable network segments. In the case of TCP, data that is written to a first end-point of a TCP stream is transmitted over the network and can be read from the second endpoint of the TCP stream in the same order in which it was written. Thus, data can be communicated simply by establishing a connection and writing to the stream, without having to provide additional data communication handling.

With increasing need for protection against unauthorized network access, firewalls and other network security equipment have been introduced to fence off unwanted network communication while allowing authorized network access. As a side effect, however, these barriers sometimes create obstructions to authorized network access that prevent TCP from providing the reliable service described before. These obstructions oftentimes lead to a breakdown of the established TCP connection, causing adverse effects on the usability of networking applications. For instance, a restart of all applications of an affected communication environment could be necessary, or a user could be required to log in again.

Dramatically increasing complexity of growing data networks adds to such TCP data transmission problems.

For improving practical reliability of data networks, different solutions have been proposed.

U.S. Pat. No. 5,898,830 proposes a firewall that improves transparency to the user while providing network security by being configured as two or more sets of virtual hosts with one set of hosts responding to addresses of a first network interface of the firewall and a second set of hosts responding to addresses of a second network interface of the firewall, and by establishing DNS mappings between remote hosts to be accessed through one of the network interfaces and respective virtual hosts on that interface.

Patent Application Publication US 2004/0016000 A1 proposes to divide a video data stream into one substream to be sent on an unreliable channel and one substream to be sent on a reliable channel. For the reliable channel, the use of cTCP is proposed, which enhances native TCP by adding transmission rate control to ensure timeliness of the video data flow.

U.S. Pat. No. 6,577,630 B1 proposes a source-aware bridging scheme for supporting bridging between an unreliable network and another, reliable network. It includes steps of maintaining address lists and suitably replacing destination addresses of frames received by a Local Link Control (LLC) entity. This bridging scheme operates on the data-link layer and relates to Medium Access Control (MAC) protocols in Carrier Sense Multiple Access (CSMA) networks.

U.S. Pat. No. 6,801,927 B1 proposes a system and method for managing connections between a plurality of clients and a server in order to take workload off a host CPU. A proxy application which runs on an adapter card manages client connections by establishing TCP network connections between the proxy application and clients via the network, and by establishing bus connections between the proxy application and the server bus.

Consequently, it is an object of embodiments of the present invention to provide a method and system for transmitting data over a network that provides an easy-to-use and persistent data communication channel to the user even when the underlying network connections are barred or terminate.

### SUMMARY OF THE INVENTION

A method of transmitting data over a network, in accordance with a particular embodiment of the present invention teaches, at a first proxy computer system, receiving data from a first data channel, encapsulating the data in packets, and sending the encapsulated data packets over a second data channel comprising a firewall, and at a second proxy computer system, receiving the data packets from the second data channel, extracting the data from the data packets, and sending the data on a third data channel, wherein said data channels are connection-oriented sequential data-stream channels, and an established connection on the first data channel is maintained if an interruption of an established connection on the second data channel between the first and the second proxy computer system is detected.

By receiving data from a first data channel being a connection-oriented sequential data-stream channel, data can be delivered to the process by using common and widely used techniques and applications, such as TCP, that are stable in local networks (LAN).

By encapsulating these data in packets prior to sending the data over a second connection-oriented sequential data-stream channel, a transportation format is used that seems counterintuitive for data transmission on data-stream channels that guarantee sequential delivery. However, these packets enable a retransmission of data when the second channel breaks down and the connection is lost, such as if the connection is interrupted by a firewall on the second channel, so that the data can be re-sent as soon as a new second channel is established.

By using a connection-oriented sequential data-stream channel as a second data channel on which the packets are sent, common infrastructure for large networks (MAN, WAN) can be used, and overheads for tracking successful delivery of data packets are kept to a minimum as resources of the underlying mechanisms for guaranteed stream delivery are used.

Since the first and second data channel are separate, a connection on the first channel can be maintained even if a connection on the second channel is lost. This enables to keep the breakdown, re-connection and data re-transmittal of the second connection-oriented sequential data-stream channel transparent to users who interact only with their connection on the first channel.

In further embodiments of the method as described above, a new connection is automatically established on the second data channel if an interruption of an established connection on the second data channel is detected.

In another embodiment of the method as described above, data packets sent over the second data channel are stored in a sent cache, and/or data packets are re-sent if an interruption of an established connection on the second data channel is detected. Additionally, embodiments can comprise one or more of the following: that an acknowledge signal may be sent if one or more data packets are received on the second data channel, that the acknowledgement signal is embedded in one of said data packets to be sent on the second data channel, that first data channel is an inter-process communication means, that said first data channel is a TCP/IP-channel, and that said second data channel is a TCP/IP-channel.

In yet another embodiment, the data processor of the network device is further configured to enumerate the data packets. Also, the network device can further comprise means to generate acknowledgement signals for successfully received data packets, wherein acknowledgement signal generating means can be configured to embed acknowledgement signals in data packets to be sent over the second data channel.

Another embodiment of the invention provides a network device for performing the method above, comprising at least one interface, a data processor, and a cache memory, wherein the interface is configured to receive data from a first connection-oriented sequential data-stream channel and send data packets over a second connection-oriented sequential data-stream channel, the data processor is configured to encapsulate the data in data packets, and the cache memory is configured to store sent data packets.

By having a cache memory, the network device can store packets that have been sent and retrieve them for re-sending in case of a connection breakdown on the second channel. The network device can be implemented as a properly configured stand-alone computer system,

Another embodiment of the invention provides a network device for further performing the method above, comprising at least one interface and a data processor, wherein the interface is configured to receive data packets sent over a second connection-oriented sequential data-stream channel and send data to a first connection-oriented sequential data-stream channel, and the data processor is configured to extract the data from the received data packets.

By providing a receiving interface to the second connection-oriented sequential data-stream channel, data packets which have been sent by a complementary network device on the other endpoint can be received. Data contained in these packets can be extracted and written to a first data channel, at the end of which a user at local host can read the transmitted data.

Other embodiments provide a corresponding data processing program, computer program product, computer data signal and a network data structure embodied as TCP segment and will be explained later.

The invention and its embodiments will be further described and explained using several figures.

### BRIEF DESCRIPTION OF THE DRAWINGS

The present invention and its advantages are now described in conjunction with the accompanying drawings.

FIG. 1 is a block diagram showing a system overview comprising a possible configuration in use;

FIG. 2 is a block diagram showing a detail from the cache memory in use;

FIG. 3 is an illustration of a possible network data structure sent over the second channel;

FIG. 4 is a flow diagram of the normal send/receive operation according to an embodiment of the invention;

FIG. 5 is a flow diagram showing connection the establishing and closing of connections and handling of connection breakdowns.

It is to be noted, however, that the appended drawings illustrate only example embodiments of the invention, and are therefore not considered limiting of its scope, for the invention may admit to other equally effective embodiments.

### DETAILED DESCRIPTION

Connection-oriented sequential data-stream channels, such as of the globally established TCP/IP protocol used in the internet, are generally intrinsically reliable. Nevertheless, network complexity and intervening barrier hosts sometimes create obstructions that prevent native TCP from offering the reliability of connections that it was designed to guarantee. In these cases, an additional pair of midpoint hosts, building a TCP Persistent Straddle (TPS), provides to overcome these obstacles that native TCP cannot. Below, the TPS, its fundamental principles, its design, and some scenarios under which a TPS configuration might be employed, are described.

As such, TCP tunnels and TCP gateways are known. For instance, the very common Secure Shell (SSH) natively provides tunnelling over TCP. As described in the introduction, some protocol implementations exist to improve the reliability of object delivery over TCP.

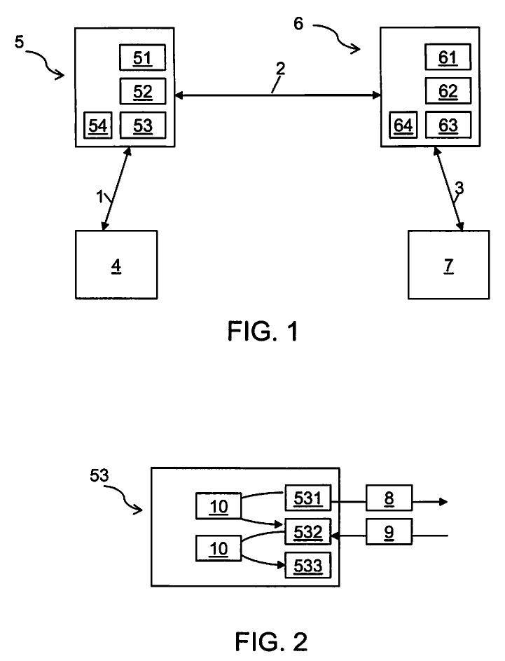

As a first overview, the main principles of a TPS system according to the present invention are illustrated in FIG. 1: end-points 4 and 7 connect over a TCP tunnel 2, and end-point connections 1 and 3 to the tunnel servers 5 and 6 remain established in case the connection 2 breaks down. In particular, in the TPS, the TCP stream is encapsulated into objects or packets and the objects or packets are reliably delivered over a TCP data stream, even when the TCP stream is not continuously established; this in particular provides a more reliable end-to-end communications channel than currently exists.

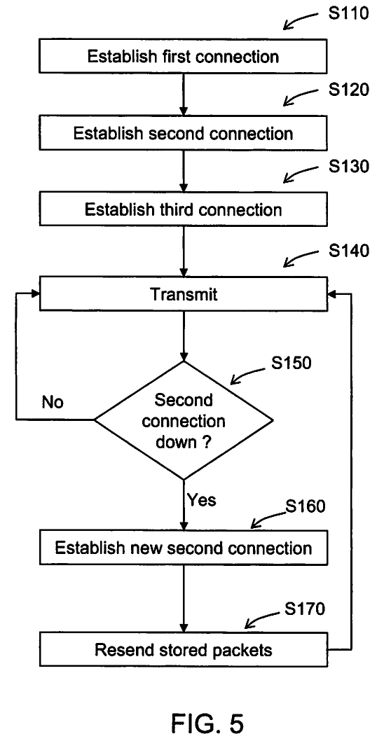

Now referring to both FIGS. 1 and 5, an end-point 4 and a first TPS host 5 establish a first connection 1 in step S110. The TPS host 5 can be implemented as a network host computer or a network adapter within a computer, a process or thread within a computer system, or as another network device. TPS host 5 and TPS host 6 establish a second connection 2 in step S120. TPS hosts 5 and 6 would typically be configured as similar peers, each having full send and receive capabilities (full duplex) so that the TPS hosts appear transparent (stateless in respect to the order of send/receive requests) to the local and foreign hosts. In an alternative implementation, they can be configured complementary to each other, for instance, as client and server with asymmetrical functionality. TPS host 6 and endpoint 7 establish a third connection 3 in step S130. All connections mentioned realize connection-oriented sequential data-stream channels, such as TCP.

Now, in step S140, data from the TCP stream of connection 1 is reliably transmitted until the connection is regularly closed by a user or application. If the connection 2 is detected to be broken in step S150 (details below), TPS hosts 5 and 6 establish a new connection 2 in step S160 and resend packets that have been sent but not arrived in step S170. Normal reliable data transmission continues in step S140.

The details of data transmission and resending are now described referring to FIGS. 1 and 4. Data sent by endpoint 4 is read from the incoming TCP data stream of connection 1 by interface 51 of TPS host 5 in step S10. Data processor 52 encapsulates the data in data packets and prepares the packet for sending by adding a header including a packet identifier and a length indicator in step S20, as will be described later. A copy of the packet is stored in cache memory 53 in step S30. TPS host 5 sends the packet to TPS host 6 via interface 51, and connection 2 in step S40. In step S50, TPS host 6 receives the packet via interface 61 and extracts the data in step S60. TPS host 6 sends back an acknowledge signal in step S70 and sends the data to local endpoint 7 through interface 61 and via TCP data stream of connection 3.

In step S70, with the exception of a packet being complete, no further test on data integrity of the received packet is needed before sending the acknowledgement signal, since connection 2 guarantees the consistency and sequence of the data that is received. Here, a significant benefit from sending the data packets over an connection-oriented sequential data-stream channel, such as TCP, becomes clear. To verify that a packet that has arrived is complete, the length indicator mentioned above can be used.

In a specific embodiment, the acknowledgement signal for the received data packet that has the largest identifier value is embedded in a data packet of regular data traffic that is sent from TPS host 6 to TPS host 5 in the opposite direction.

On receipt of the acknowledgement signal for a packet, TPS host 5 discards the respective copy of the successfully sent packet in step S90. This process is shown in further detail in FIG. 2. Packets to be sent are first stored in a send queue 531, which in this example is part of the cache memory 53. Upon sending a packet 8, a packet copy is stored in the sent cache 532. When an acknowledgement signal 9 is received after successful reception of packet 8 at TPS host 6, said packet copy is moved to packet trash 533, or, simply deleted from memory.

If, however, a failure of connection 2 is detected, all packet copies residing in the sent cache 532, i.e. packets which were sent but have not been deleted because no corresponding acknowledgement signal has arrived, are moved to the send queue 531 for regular (re-)transmission as soon as a new connection 2 is established.

To detect if connection 2 is still up, TPS hosts 5 and 6 send heartbeat packets at regular intervals when the data send direction is idle. Either TPS host not receiving any packet (data or heartbeat) after a specified interval has detected a failure of connection 2. In this case, the TPS host drops the connection 2 and establishes a new connection 2 by, in the case of TCP, one TPS host listening for a new connection on an agreed port number while the other TPS host initiates a new connection. Once the connection 2 is re-established, transmission continues normally. In a specific embodiment where acknowledgements are attached to data packets sent in the other direction, it may be desirable to send an additional acknowledgement with the largest successful packet received if there is no other packet to send.

Regarding the use of send queue 531, it may be desirable to perform flow-control via send/receive-matching, since the three TCP connections (1, 2 and 3 in FIG. 1) may have different band widths. To prevent TPS host 5 host from caching an unproportional amount of data relative to the amount of data that the TPS host can forward, flow control should be implemented. Another synergic effect is exploited when TCP is used and socket receives are only initiated when buffers are low, since in that case TPS host relies on the underlying TCP/IP protocol implementation for flow control.

Although only described in detail in one direction, namely the transmission of data from local endpoint 4 over connection 1 via TPS host 5 and connection 2 and TPS host 6 to foreign host 7 over connection 3, it should be clear that the system would typically be configured full duplex to allow data transmission be performed in the opposite way.

A single TPS host 5 to TPS host 6 connection 2 can service any number of connections between local hosts and foreign hosts by multiplexing the “packets” from all local hosts over a the single TPS host 5 to TPS host 6 connection 2 to all respective foreign hosts.

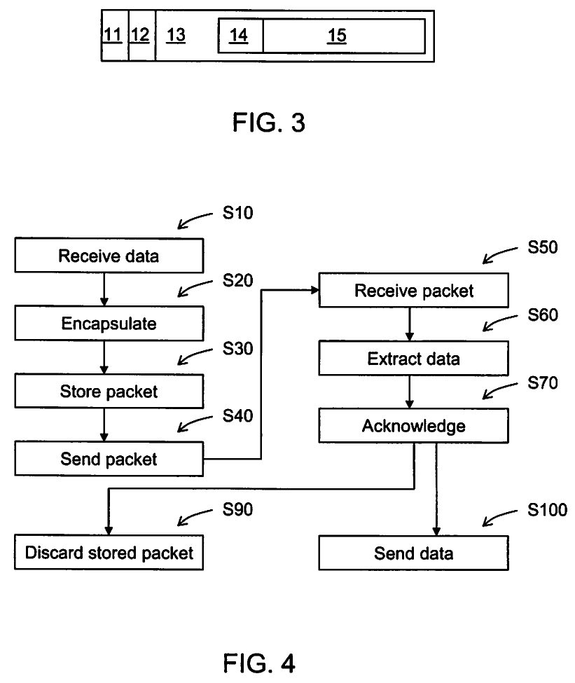

FIG. 3 shows a possible datagram in the specific case that the present invention is used with a TCP/IP network connection. In this case, since an TPS-packet is sent over a TCP stream which in turn is transmitted in the form of IP datagrams, such a typical datagram found on connection 2 consists of an IP datagram header 11, followed by a TCP segment header 12, and in the data space 13 of the TCP datagram there is the TPS data packet comprising a header 14 and a data load space 15. As described above, the packet header 14 comprises a packet identifier, such as a number, and a packet length indicator.

The TPS system can be adapted to work in a variety of application scenarios. Further configurations are described in the following examples.

For instance, a reliable connection can be established between an intranet and the Internet over a proxy server of the local site. In this case, the local TPS host residing on the intranet establishes a connection to the local proxy server first. The TPS host then sends a connection request to the proxy (http-connect, socks, etc.) to establish a connection to the TPS host residing on the internet.

Such a local TPS host can also provide proxy services to local hosts in the local network. In this case, the configuration can be referred to as proxy over proxy. In fact, the proxy service (http, socks, etc.) need not be of the same type as the proxy service over which the TPS host has established its connection to its peer.

In another application scenario, TPS local port to foreign host mapping (Port Mapping) can be implemented. Here, a local TPS host can be configured to accept connections from local hosts on a specific TCP port which is assigned to a respective connection to a foreign host.

When a local host wishes to establish a connection to a foreign host, the local host would simply connect to the specified port of the TPS host instead. The remote TPS host would subsequently establish a connection to the foreign host.

In another configuration, TPS midpoint 5 is not necessarily accessed via a local network but is itself running on a local host, such as host 4, as a TPS engine running in a separate process or in a thread embedded in an application. In this case, the TPS engine would be accessed by the application code either directly via API or via sockets provided by the TPS engine. For such an implementation, a single conventional socket can be provided to the application by a dedicated library function. The socket can be a TCP socket to which a second conventional socket, owned by the TPS process or thread, is locally connected. Alternatively, the socket can be a UNIX domain socket to which another UNIX domain socket is connected. During operation, the TPS engine runs in its separate process or thread and reads to and/or writes from one end of the socket pair while the application writes to and reads from the other end, respectively.

In another scenario, security of communication is enhanced by using authentication and encryption technology for communication between TPS hosts. One example is using TPS midpoints for providing general encrypted virtual private network (VPN) service. An encrypted channel between TPS hosts over Secure Socket Layer (SSL) could be produced in two ways:

In one implementation, a TPS host uses SSL sockets when communicating to its TPS peer on connection 2. Each time connection 2 is broken, a new SSL channel is established.

In another implementation, TPS hosts use conventional non-secure sockets when communicating to their TPS peers. A TPS host, e.g., a TPS engine as described above, provides a conventional but “reliable” socket, and SSL communicates over this socket. In terms of network service layers, the secure session is thus established “on top of” the reliable connection. In this way, expensive key negotiation would not take place each time the connection between TPS hosts is re-established.

The two-point Persistent Straddle (TPS) is introduced. A TPS provides reliable end-to-end communications across an unreliable TCP network. A TPS configuration consists of two intermediary servers, deemed TPS hosts or midpoints. One TPS host resides in each of two locations between which a persistent and reliable connection is to be established.

When a practically unreliable TCP connection can be established between networks A and B either directly or over gateways, and a persistent and reliable connection between networks A and B is desired, it is proposed to equip each of both networks with one of two TPS hosts. The TPS host in network A is the local TPS host for other clients in network A and the TPS host in network B is the foreign TPS host for all clients in network A (and vice-versa).

In some embodiments, at least one TPS host provides TCP proxy services via http-proxy, socks, port routing, or similar. This TPS host is the proxy destination for connections destined for the foreign network. In an alternative configuration, a TPS midpoint can be embedded within an application as described.

Local TPS hosts accept TCP connections from local hosts and foreign TPS hosts establish connections to foreign hosts as though the local hosts established direct connections to the foreign hosts. Connections between TPS hosts and local hosts are maintained even if the connection between TPS hosts is interrupted. Most importantly, endpoints connected to the TPS are always under the impression that a connection is established between them, independent of the state of the connection between the TPS midpoints.

Local TPS hosts accept data for foreign hosts on the foreign network. Received data is encapsulated in enumerated packets, cached and forwarded to foreign TPS host as conditions permit. For this purpose, TPS hosts perform a stream-to-packet conversion before forwarding the packets to the foreign TPS host over the streamed connection between the TPS hosts. Upon receiving integral packets, foreign TPS hosts send the contents to the associated foreign host over the persistent stream that exists between them.

TPS hosts keep connections to local hosts persistent. Established connections of local hosts to a TPS host are held open even when the connection between TPS hosts is broken. Both local and foreign hosts (endpoints) are continuously under the impression that a connection exists between them. So is the TCP protocol stack on all hosts. Without the intervening TPS, the respective local hosts would consider the connections to their respective partners lost when the TCP connection between networks was to break down.

The invention can take the form of an entirely hardware embodiment, an entirely software embodiment or an embodiment containing both hardware and software elements. In an embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

To avoid unnecessary repetitions, explanations given for one of the various embodiments are intended to refer to the other embodiments as well, where applicable. In and between all embodiments, identical reference signs refer to elements of the same kind. Moreover, reference signs in the claims shall not be construed as limiting the scope. The use of “comprising” in this application does not mean to exclude other elements or steps and the use of “a” or “an” does not exclude a plurality. A single unit or element may fulfil the functions of a plurality of means recited in the claims.

The invention claimed is:

1. A method of transmitting data over a network, comprising:
at a first proxy computer system receiving data from a first data channel;
encapsulating the data in packets;
sending the encapsulated data packets over a second data channel comprising a firewall;
at a second proxy computer system, receiving the encapsulated data packets from the second data channel;
extracting the data from the encapsulated data packets;
sending the extracted data on a third data channel, and;
automatically establishing a new connection on the second data channel if an interruption of an established connection on the second data channel is detected;
wherein said data channels are connection-oriented sequential data-stream channels, and wherein an established connection on the first data channel is maintained if an interruption of an established connection on the second data channel between the first and the second proxy computer system is detected.

2. The method according to claim 1, wherein the encapsulated data packets sent over the second data channel are stored in a sent cache.

3. The method according to claim 2, wherein the stored encapsulated data packets are re-sent if an interruption of an established connection on the second data channel is detected.

4. The method according to claim 3, wherein an acknowledge signal is sent if the one or more stored encapsulated data packets are received on the second data channel.

5. The method according to claim 4, wherein the acknowledgement signal is embedded in one of the stored encapsulated data packets to be sent on the second data channel.

6. The method according to claim 5, wherein said first data channel is a means for inter-process communication.

7. The method according to claim 5, wherein said first data channel is a TCP/IP-channel and/or secure-socket-layer-channel.

8. The method according to claim 7, wherein said second data channel is a TCP/IP-channel and/or secure-socket-layer-channel.

9. A network device comprising:
at least one interface configured to receive data from a first connection-oriented sequential data-stream channel and send data packets over a second connection-oriented sequential data-stream channel;
a data processor configured to encapsulate the data in data packets, and;
a cache memory configured to store sent data packets.

10. The network device of claim 9 wherein the interface is also configured to receive data packets sent over the second connection-oriented sequential data-stream channel and send data to the first connection-oriented sequential data-stream channel, and wherein the data processor is also configured to extract the encapsulated data from the received data packets.

11. The network device according to claim 10 wherein the data processor is further configured to enumerate the data packets.

12. The network device according to claim 11, further comprising means for generating acknowledgement signals for successfully received data packets.

13. The network device according to claim 12 wherein said means for generating acknowledgement signals are configured to embed acknowledgement signals in the data packets to be sent over the second data channel.

14. A computer program product stored on a computer usable medium, comprising computer readable program means for causing a computer to perform a method comprising:
at a first proxy computer system receiving data from a first data channel;
encapsulating the data in packets;
sending the encapsulated data packets over a second data channel comprising a firewall;
at a second proxy computer system, receiving the encapsulated data packets from the second data channel;
extracting the data from the encapsulated data packets;
sending the extracted data on a third data channel, and;
automatically establishing a new connection on the second data channel if an interruption of an established connection on the second data channel is detected;
wherein said data channels are connection-oriented sequential data-stream channels, and wherein an established connection on the first data channel is maintained if an interruption of an established connection on the second data channel between the first and the second proxy computer system is detected.

15. The computer program product according to claim 14, wherein the encapsulated data packets sent over the second data channel are stored in a sent cache.

16. The computer program product according to claim 15, wherein the stored encapsulated data packets are re-sent if an interruption of an established connection on the second data channel is detected.

17. The computer program product according to claim 16, wherein an acknowledge signal is sent if the one or more stored encapsulated data packets are received on the second data channel.

18. The computer program product according to claim 17, wherein the acknowledgement signal is embedded in one of the stored encapsulated data packets to be sent on the second data channel.

19. The computer program product according to claim 18, wherein said first data channel is a TCP/IP-channel and/or secure-socket-layer-channel.

20. The computer program product according to claim 18, wherein said second data channel is a TCP/IP-channel and/or secure-socket-layer-channel.
